(19) United States
(12) Patent Application Publication
(10) Pub. No.: US 2026/0116581 A1
(43) Pub. Date: Apr. 30, 2026

(54) UTILIZATION OF SWARMS FOR SAMPLE RETURN AND MULTIPOINT OBSERVATION USING INFLATABLES

(71) Applicant: Arizona Board of Regents on Behalf of the University of Arizona, Tucson, AZ (US)

(72) Inventors: Jekan Thangavelautham, Tucson, AZ (US); Massimo Biella, Tucson, AZ (US); Sivaperuman Muniyasamy, Tucson, AZ (US); Leonard Vance, Tucson, AZ (US); Athip Thirupathi Raj, Tucson, AZ (US)

(21) Appl. No.: 19/158,241

(22) PCT Filed: Feb. 27, 2024
(86) PCT No.: PCT/US2024/017433

§ 371 Date: Aug. 20, 2025

Related U.S. Application Data
(60) Provisional application No. 63/448,519, filed on Feb. 27, 2023.

(51) Int. Cl. B64G 1/10; B64G 1/22; B64G 1/36; B64G 1/64

(52) U.S. Cl. CPC B64G 1/1085; B64G 1/2227; B64G 1/36; B64G 1/646

(57) ABSTRACT

The present disclosure provides a system for utilization of swarms for sample return and multipoint observation using inflatables. The system includes a communications circuitry; a signaling circuitry; an inflatable structure; and a first controller, the first controller configured to: receive a message from a target spacecraft indicating a need to be captured; acknowledge the message from the target spacecraft; receive sensitive data from the target spacecraft; determine a location on the inflatable structure for capturing the target spacecraft; signal the target spacecraft to the location; and capture the target spacecraft.

### CROSS-REFERENCE TO RELATED APPLICATIONS

The present application claims the benefit of the filing date of U.S. Provisional Application Ser. No. 63/448,519, filed Feb. 27, 2023, the entire teachings of which application is hereby incorporated herein by reference.

### STATEMENT REGARDING FEDERALLY SPONSORED RESEARCH OR DEVELOPMENT

This invention was made with government support under 80NSSC19M0197 awarded by the National Aeronautics and Space Administration. The government has certain rights in the invention.

### TECHNICAL FIELD

The present application relates generally to inflatable structures and, more particularly, to a system and method for utilization of swarms for sample return and multipoint observation using inflatables.

### BACKGROUND

Since the 1960 Echo 1 mission, NASA has considered inflatable structures as a viable alternative for structural applications that would otherwise employ heavier, rigid materials. Due to their expansion capabilities, inflatables can be packed into small volumes, making them very suitable for space applications since both volume and mass come at a premium. Over the past few decades, there have been several proposals for using inflatables as habitat structures to be used on the surfaces of the Moon and Mars, as well for deep space exploration. With the advent of miniaturization of electronics, the number of CubeSats launched to Low Earth Orbit (LEO) and Deep Space is rapidly increasing. Missions like NASA's Inflatable Antenna Experiment (IAE) in 1996 paved the way for the use of inflatables for communication applications. Furthermore, inflatable structures have a great potential to play the role of dampers for high-speed space applications, similar to the Entry Descent and Landing (EDL) Mechanisms used in NASA Mars Lander Missions.

While CubeSats have shown great promise in achieving the science objectives that conventional large satellites were able to reach just a decade ago, their potential to perform cooperative maneuvers remains mainly untapped by current technology. Inflatables present an innovative way to reduce the relative velocity between spacecraft of different mass and volume at different angles of impact. Disclosed herein is a novel approach for a swarm of spacecraft to perform multi-point observation, sample return, or orbital debris cleanup. The key is to enable such capabilities using a team of simple spacecraft that can diffuse into a target environment, perform capture or observation readings, and then be effectively gathered by a mothership at low risk of collisions. Inflatables offer the promise of large expandable structures that can be used to collect and attach nanospacecraft. Such inflatable structures may be used to electrically charge the onboard batteries on a nanospacecraft to ensure all the data is collected to the mothership. The inflatable may then separate from the mothership with all the collected nanospacecraft and perform a disposable maneuver. Such an approach can reduce the risk of a mothership colliding with a swarm of nanospacecraft. In addition, it can enable the utilization of a swarm approach where the nanospacecraft have limited guidance, navigation, and control capabilities.

### BRIEF DESCRIPTION OF THE DRAWINGS

Reference should be made to the following detailed description which should be read in conjunction with the following figures, wherein like numerals represent like parts.

FIG. 1 is a table comparing deployable technologies.

FIG. 2 is a table of swarm classifications for spacecraft.

FIG. 3 is an example of inflatable deceleration using an inflated annular sleeve.

FIG. 4 is an image defining parameters of an incoming object in order to analytically establish drag force, along with a chart of deceleration and stopping distance for a variety of inflatable pressurization levels and object sizes.

FIG. 5 is an example partial system block diagram of an inflatable structure.

FIG. 6 is illustrative example of the operations of operations for spacecraft applications consistent with the present disclosure.

FIG. 7 is an illustrative example of the operations of operations for air drone applications consistent with the present disclosure.

FIG. 8 illustrates several example inflatable geometries consistent with the present disclosure.

FIG. 9 is an example of “hit” and “miss” trajectories for both linear and tumbling trajectories, consistent with the present disclosure.

FIG. 10 is an illustrative example of thruster malfunction.

FIG. 11 is an example block diagram of operations for swarm traffic management using Visible Light Communication (VLC), consistent with the present disclosure.

FIG. 12 is a table of the success rate of Monte Carlo simulations for a variety of solid geometries, consistent with the present disclosure.

FIG. 13 is an illustrative example of the trajectories of 100 spacecraft needing to be caught by the inflatable with randomized initial conditions.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

The miniaturization of electronics, sensors and actuators have resulted in a significant reduction in the mass and volume of a spacecraft. Small spacecraft are growing in number and capabilities. One emergent area utilizing multiple small spacecraft (spacecraft swarms) shows promise in extending capabilities in planetary exploration. Multiple spacecraft enable parallel tasking and increased redundancy over a single monolithic spacecraft. Swarms of spacecraft maybe used to map entire small bodies in a series of timed rendezvous. Spacecraft swarms are also ideally placed to perform multipoint observation of complex events of interest. More recently the potential for swarms of spacecraft to perform sample return has been shown, by capturing objects being emitted from a comet or an asteroid.

All of these potential capabilities make spacecraft swarms a valuable new tool in extending exploration to the remaining far corners of the solar system. However, one of the major challenges in spacecraft swarms is coordinating dispersal maneuvers from a mothercraft and retrieval (gathering maneuver). Such maneuvers may require complex scheduling and traffic management. Furthermore, not all spacecrafts in a swarm maybe able to perform a gathering maneuver due to running of out fuel or damage to propulsion or Guidance, Navigation & Control (GNC) subsystems. The inability to retrieve these damaged crafts could cause a hazard to the mission or produce space debris. An effective method is needed that simple, scalable, and robust to gather the swarm.

Disclosed herein is a system utilizing an inflatable structure attached to a mothership to safely capture swarms of small spacecraft or air drones with degraded guidance, navigation, and control capabilities, ranging from thruster or propeller malfunctions, to damaged cameras and sensors that would preclude the vehicles from returning to a mothercraft safely, without damaging themselves or the environment and the actors around them. The use of a large inflatable simplifies the capture and retrieval of the spacecraft swarm. Inflatable structures have already been widely applied in space, including from construction of large communication antennas, to inflatable habitats. More applications are on the way including application of inflatables to rovers, use of balloons, airships, and sailplanes.

The disclosed application of inflatables to retrieve an entire swarm is novel and may be used as a robust fail-safe method to retrieve many individual spacecrafts or robots all at once. The applications goes beyond spacecraft swarms to drones and Unmanned Aircraft System (UAS) swarms. Inflatables are fundamentally simple devices that can rely on highly exothermic reactions to fully deploy in a matter of seconds much like the Mars Exploration Rover lander bags.

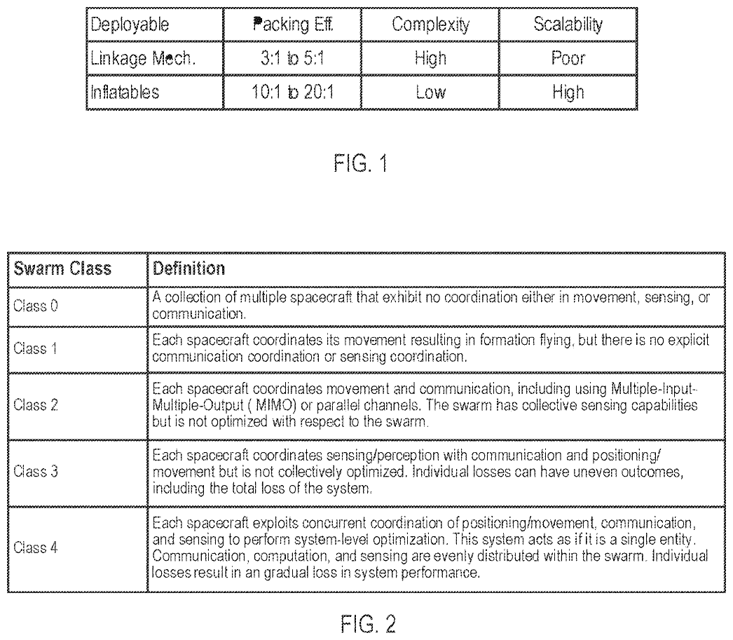

Inflatable space structures are playing an increased role in a multitude of space applications ranging from instrument and communication antennas, to support structures, habitats, landing systems, and even hypersonic aeroshells. High energy deployment systems can lead to residual dynamics and a spectrum of vibration modes which require effective damping and/or suppression. Although there are multiple factors that may contribute to uncontrollable modes, as a general rule, the lower the energy released upon deployment, the smaller the bandwidth of such modes. These modes are governed by two fundamental characteristics of the structure's design. The first is the structure's material and geometric design and the second is its deployment mechanism. The table of FIG. 1 shows a comparison between different deployable technologies used in space. From the study, it can be inferred that thin membrane inflatables offer the highest packing efficiencies for lowest mass of the structure.

Membrane inflatables belong to a larger class of structures termed as gossamers. Gossamers represent ultra-lightweight structures often built out of compliant members. In the case of inflatable gossamers, stiffening is provided pneumatically by an inflation gas. Inflatable membrane structures have been researched extensively. Between the 1950's and 1960's, Goodyear developed inflatable structure concepts for a variety of applications. This included inflatable truss structures for search antennas, spherical inflatables for radar calibration and lenticular parabolic reflectors. The research focused on creating very large deployable space structures. This was followed by the largely successful ECHO balloon missions. ECHO 1 and ECHO 2 were highly successful large and high precision space structures. Their construction was based on aluminum foil laminate Mylar and were shaped to be large spheres based on the objective of passive, space-based communication reflectors. The main issue encountered was shape accuracy.

The first major orbital demonstration of an inflatable membrane system came with the inflatable antenna experiment. The Inflatable Antenna Experiment was flown by NASA on space shuttle mission STS-77 in May 1996. The structure consisted of a parabolic reflector with inflatable support beams that deployed out of a box. The mission's objective was to visually verify the deployment process which was based on ejection caused by venting of residual air trapped during packing. Though the inflatable antenna deployed as expected, it remained largely uncontrolled. This was due to inaccurate estimates of the forces generated by the residual outgassing air. Research at ILC Dover has focused on inflatable airbags for soft landing of payloads upon planetary decent. This technology has been successfully demonstrated for the Mars Pathfinder mission and the Mars Exploration Rover missions. These inflatables are designed for rapid deployment and are constructed out of high strength woven fabrics such as Vectran. A major application that potentially stands to benefit from large inflatable structures are atmospheric decelerating structures, which may be used for atmospheric entry or for de-orbiting. NASA's Langley research center has been developing the Hypersonic Inflatable Aerodynamic Decelerator (HIAD) program. HIAD uses aeroshell technology to build large inflatable structures for entry into through the Martian atmosphere. Acroshell technology uses multiple inflatable membranes enclosed by a flexible heat shielding system. The load bearing inflatable structure is layered with a robust flexible thermal protection system (FTPS) to endure thermal loads upon entry.

The usage of spacecraft swarms for exploration is a concept still in its infancy. The vast majority of effort in space exploration missions thus far has focused on increasing performance and reliability of a single mission spacecraft. In many, if not most cases, this is arguably the correct approach since the missions can be accomplished with that single spacecraft, but the increased costs in spacecraft complexity and mission assurance are significant. Notably, not all missions adapt easily to the single spacecraft architecture. In the case of the current Martian rovers, the ability to add mobility to a landed mission is undoubtedly a huge leap forwards in capability, but the distance covered is measured in the tens of kilometers, on a planet which is over 21,000 km in circumference. Would science have been better served to land a swarm of smaller landers distributed around the planet before following up with the more capable rovers such as Curiosity and Perseverance? Without knowing the true variation of geology on the surface, it is difficult to quantify, but still arguable.

Another argument highlights the dangers of overspecialization in an arena where inadequate information about the mission site exists. The Viking landers in 1976 provide a case in point in which the highly complex and detailed experiments to determine whether there was life on Mars resulted in a more immediate understanding that we should be working to establish what the Martian environment is and was before attempting to search for life forms. Here, it is arguable that a larger number of landers over a wider variety of geological features could have informed a more intelligent methodology.

Relatively few swarm approaches to space exploration have been proposed thus far, although the concept of optimized swarm image reconnaissance has been explored. In 2018, a NASA discovery mission was proposed utilizing a swarm of 32 disposable 3U CubeSats to map low altitude magnetic field anomalies on the moon. Although ultimately unsuccessful in securing funding, the overall technique showed a sound approach towards using a large number of disposable spacecraft to gather magnetic (and other) measurements from a wide variety of lunar locations for detailed mapping of anomalies detected from higher orbit.

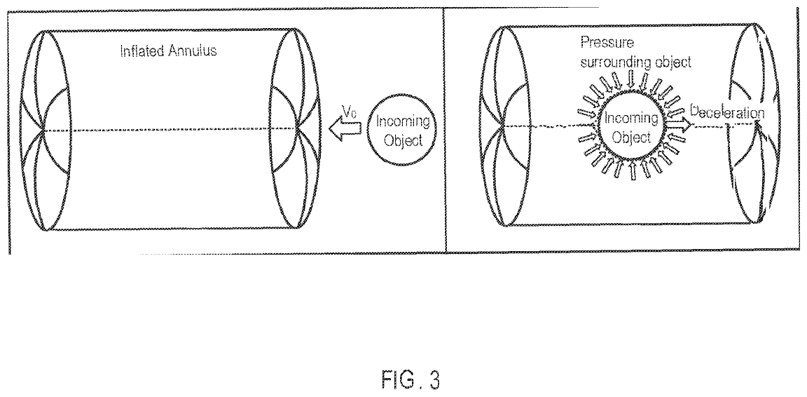

Some cases of swarm cooperation have been flown such as one regarding two spacecraft observing lunar gravitational models, but largely, swarms as they have been deployed to date largely consist of earth orbiting constellations for image surveillance or worldwide communications links. One notable exception is the swarm observation for the Double Asteroid Redirection Test (DART) mission, which, although it was reduced to a single extra observation satellite, still operated in concert for a multiple view flyby of Didymos in September 2022. Excepting the even distribution of sensing and computational capabilities, this mission could plausibly be classified at level 4 by the Nallapu and Thangavelautham standards shown in the table in FIG. 2. Finally, in February of 2022, NASA selected HelioSwarm for an Explorer level mission. A mothership with 8 small spacecraft orbit the earth between geosynchronous and lunar altitudes to establish concurrent solar plasma measurements across a variety of positions. This mission corresponds to a type 1 swarm as defined in the table in FIG. 2.

In some embodiments, the basic concept used for capturing an uncontrolled incoming object is using some variant of an inflated receiving mechanism enclosing the incoming object and slowing it in a controlled fashion. Equation (1) is a first order model for the drag friction on a spherical object surrounded by an inflated object using the classic linear friction model.

$${F}_{drag} = k {F}_{normal} \qquad ( 1 )$$

Given that the pressure, P, exerted by the inflatable is assumed constant over the entirety of the object's surface, there is a delta force δF exerted over an infinitesimal surface area 8S as shown in Equation (2).

$$δ F = P δ S \qquad ( 2 )$$

Referring to the conventional frictional drag Equation (1) above, the tangential force on that small differential surface area δS is shown in Equation (3).

$$δ {F}_{drag} = k P δ S \qquad ( 3 )$$

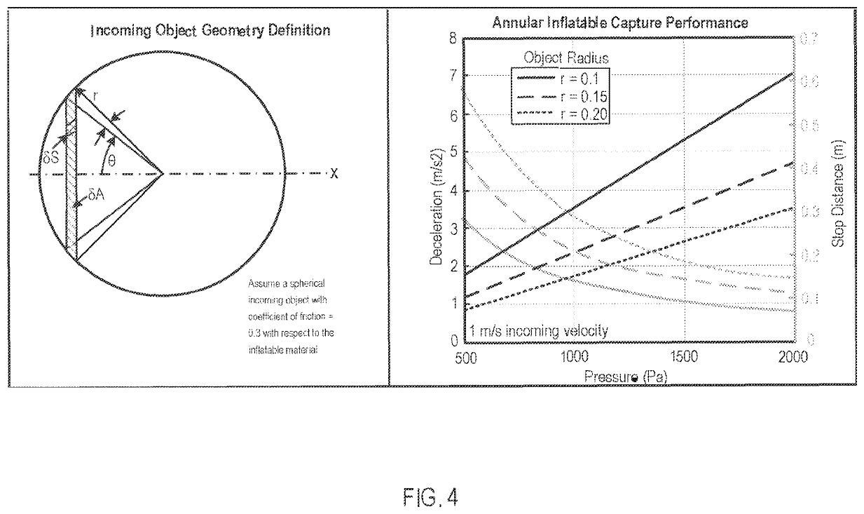

It should be noted that this problem is symmetric about the longitudinal (x) axis of the incoming object, so it is convenient to further define an infinitesimal surface area δA which comprises a ring on the surface of the incoming object, symmetric about the x axis and as described in the left frame of FIG. 4. The resulting area SA is given by Equation (4).

$$δ A = 2 π {r}^{2} sin ( θ ) δ θ \qquad ( 4 )$$

Drag force in the x direction as a result of pressure on the surface δA is then the sum of pressure over area δA, resolved into the x direction by sin (θ), giving Equation (5).

$${F}_{x , δθ} = P k sin ( θ ) δθ \qquad ( 5 )$$

It should be noted that drag forces in the y and z directions are symmetric about the x axis, and this results in a net force value of zero, but there is an x value which can be obtained by combining the above with Equation (4) and integrating over the entire sphere from θ=0 to π, resulting in Equation (6).

$${F}_{x} = 2 π {r}^{2} P k {\int }_{θ = 0}^{π} {sin}^{2} ( θ ) δθ \qquad ( 6 )$$

Evaluating this integral produces the following simplified expression for total drag force of Equation (7).

$${F}_{x} = {\vert}_{θ = 0}^{π} 2 π {Pkr}^{2} ( \frac{θ}{2} - \frac{{sin}^{2} ( θ )}{4} ) = {π}^{2} {r}^{2} P k \qquad ( 7 )$$

With this equation, there is a deceleration force which is constant, at least from the time the object is encompassed to the moment it stops. By making some reasonable assumptions about density, coefficient of friction and incoming velocity, distance needed to stop and resulting deceleration may be calculated as a function of the inflatable enclosure pressure. This can be seen in the right frame of FIG. 4. Given a nominal density of 2 g cm⁻³, the mass of the incoming object may be calculated as a function of radius. Further assuming a reasonable linear friction coefficient of k=0.3, and an incoming object velocity of V0=1 ms⁻¹, pressures of P=1 kPa (about 1% of an atmosphere) are needed to produce reasonable deceleration ranging from 1 to 2 ms⁻² and resulting stop distances of 0.1 to 0.3 m. FIG. 3 is an example of inflatable deceleration using an inflated annular sleeve.

Although the system disclosed herein using an inflatable structure to safely capture spacecraft with degraded GNC was sparked by the need to preserve the contents of the small satellite, such as regolith collected in a sample return mission, the system may also be of use in the safe capture of air drones with analogous navigation and control issues. FIG. 5 is an example partial system block diagram of an inflatable structure. The example of FIG. 5 includes sensors 510, which may include Light Detection and Ranging sensor (LIDAR) 512 and pressure sensors 514; instrumentation 520 which may include controller 522; and actuators 530.

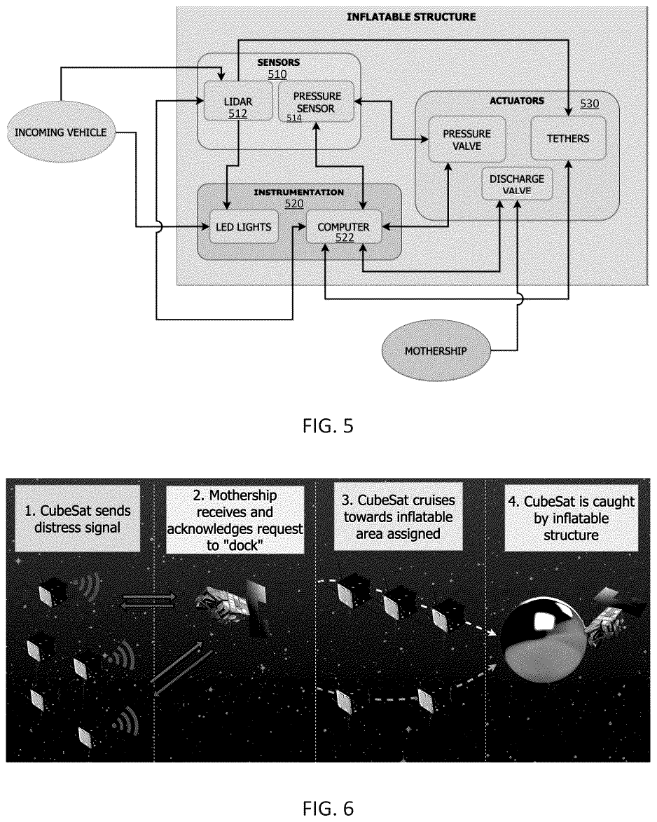

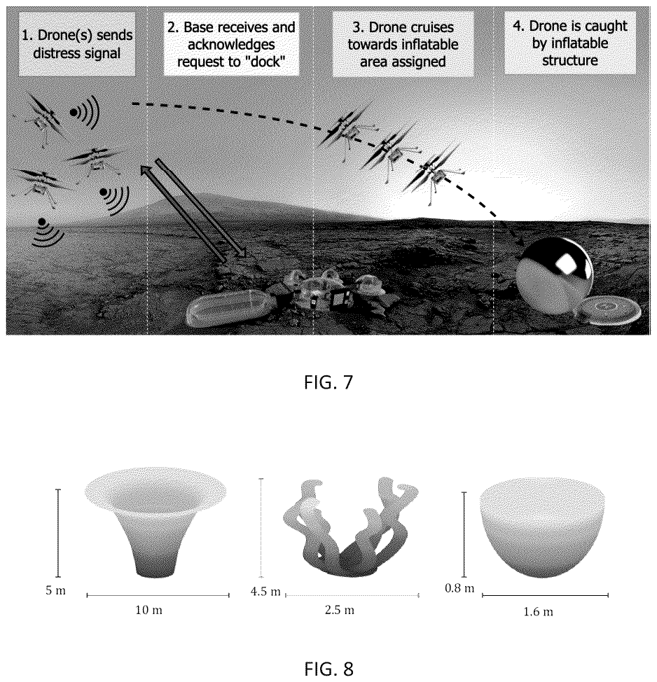

In space, the target spacecraft with degraded GNC capabilities communicates to the mothership and to the other spacecraft composing the swarm of its special need to be docked, or captured, by the inflatable structure. Once a distress signal is sent out, the mothership acknowledges the distress signal and begins communicating with the spacecraft to acquire sensitive data such as the relative position of the two spacecraft, velocity, mass, and possible malfunctions. Then, the depending on the spacecraft's GNC capabilities, it is cleared to a specific spot on the inflatable surface by signaling with, for example, a sequence of lighting cues analogous to those used on runaways on Earth. The system then commences the impact procedure and subsequent capture of the vehicle. FIG. 6 is an illustrative example of the operations for spacecraft applications consistent with the present disclosure, while FIG. 7 is an example of how a comparable system may be used to capture air drones with degraded navigation capabilities both on Earth and on other celestial bodies.

To increase the likelihood of successfully capturing the target spacecraft, the disclosed system may support different inflatable geometries. FIG. 8 illustrates several example inflatable geometries consistent with the present disclosure. Below, a semisphere geometry, a “bell flower” geometry, and a cuttlefish-like geometry are compared by performing Monte Carlo simulations. The CAD models for the three shapes are recreated to be represented by a fine mesh of points and set inside a computational domain, aligning their long side with the direction of movement of the incoming spacecraft (z-axis). The geometries' sizing was performed to account for a fixed volume of gas that will be injected into the structure during deployment. For such reason, the models present very different lengths along their z-axis when compared to each other. The volume was kept constant at 1.02 m³.

Equation (8) explicates how the spacecraft's position, linear and angular velocities are determined for the three different coordinate axis in the inertial frame attached to the inflatable structure. First the computational domain is defined in the xyz frame.

$$\{ \begin{matrix}{x}_{range} = [ {x}_{0} , {x}_{1} ] \\ {y}_{range} = [ {y}_{0} , {y}_{1} ] \\ {z}_{range} = [ {z}_{0} , {z}_{1} ] \\ {ω}_{range} = [ {ω}_{0} , {ω}_{1} ]\end{matrix} \qquad ( 8 )$$

The values of ωₐᵣₑ kept constant with ω₀=0 and ω₁=π, while the range of possible axial velocities is given by Equation (9).

$$\{ \begin{matrix}{\dot{x}}_{range} = [ {\dot{x}}_{0} , {\dot{x}}_{1} ] \\ {\dot{y}}_{range} = [ {\dot{y}}_{0} , {\dot{y}}_{1} ] \\ {\dot{z}}_{range} = [ {\dot{z}}_{0} , {\dot{z}}_{1} ]\end{matrix} . \qquad ( 9 )$$

The set of initial conditions is then generated randomly by running a loop to fill out an n-sized array of 10 columns, with columns 7-10 containing the randomized angular velocity prescribed to the spacecraft as shown in Equation (10).

$$\{ \begin{matrix}IC ( i , 1 ) = rand [ ( {x}_{range} ( 2 ) - {x}_{range} ( 1 ) ] + {x}_{range} ( 1 ) \\ IC ( i , 2 ) = rand [ ( {y}_{range} ( 2 ) - {y}_{range} ( 1 ) ] + {y}_{range} ( 1 ) \\ IC ( i , 3 ) = rand [ ( {z}_{range} ( 2 ) - {z}_{range} ( 1 ) ] + {z}_{range} ( 1 ) \\ IC ( i , 4 ) = rand [ ( {\dot{x}}_{range} ( 2 ) - \vert {\dot{x}}_{range} ( 1 ) ] + {\dot{x}}_{range} ( 1 ) \\ IC ( i , 5 ) = rand [ ( {\dot{y}}_{range} ( 2 ) - {\dot{y}}_{range} ( 1 ) ] + {\dot{y}}_{range} ( 1 ) \\ IC ( i , 6 ) = rand [ ( {\dot{z}}_{range} ( 2 ) - {\dot{z}}_{range} ( 1 ) ] + {\dot{z}}_{range} ( 1 ) \\ IC ( i , 7 : 10 ) = rand [ ( {ω}_{range} ( 2 ) - {ω}_{range} ( 1 ) ] + {ω}_{range} ( 1 )\end{matrix} \qquad ( 10 )$$

To carry out the simulations, a computational domain of 5 meters (m)×5 m×10 m was defined, while the initial conditions of the spacecraft were randomly generated and stored in an array of n=100 cells. For the three different structures, the spacecraft's initial position and velocities in 3-axis were defined by generating a random number within the bounds of the computational domain. For instance, if the x-axis extends from x₀=0 m to x₁=5 m, and a velocity range [−2,2] meters per second (ms⁻¹) is defined, the initial position of the spacecraft is determined to be a random number between [0,5] m and added to x₀=0 m, while its x-velocity is defined by randomly generating a number between [0,4] m s⁻¹ and adding it to x⁻=−2 m s⁻¹.

With 100 pairs of position and velocity initial conditions defined, a function is defined to detect whether the spacecraft are caught by the inflatable structures or not. For the simulation, the code is unable to detect and process a 2D or 3D surface, therefore a fine mesh of points is generated to represent the surface as accurately as possible. The function receives the test mesh, the computational domain size, and spacecraft initial conditions, and propagates their trajectory with a timestep t=0.0001 seconds, until the spacecraft is considered caught, or the simulation reaches an arbitrary maximum number of itₘₐₓ=1,000,000 iterations. Such a limit is implemented to prevent the simulation from stagnating while waiting for a very slow and off course spacecraft to hit the structure or exit the domain.

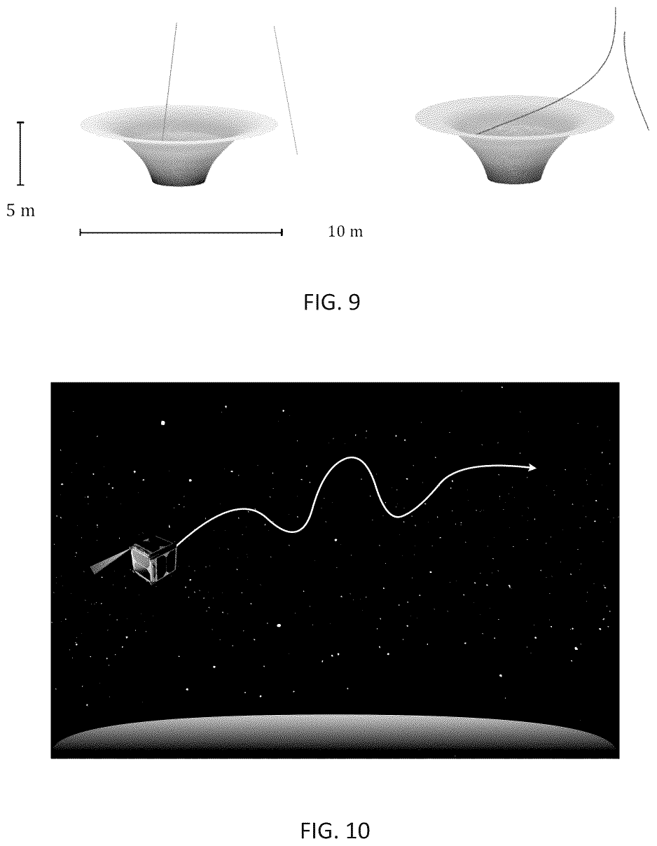

As the spacecraft trajectory propagates, during each iteration, the code checks whether the spacecraft hit a point of the mesh by checking whether a point is found to be within d=1 mm in all three axis. If that condition is found to be true, an energy dissipation coefficient is applied to the state space vectors of the spacecraft to account for the energy transfer due to the impact and subsequent energy loss due to friction with the inflatable structure. Such coefficient heavily depends on both the material properties of the inflatable surface and on the pressure that is exerted from the gas inside it. The spacecraft is then headed into a different direction, waiting for either a series of impacts that will lead to its successful capture or for its crossing of the computational domain boundaries, scoring a “miss.” If the maximum number of iterations is reached before a hit or a miss are recorded, the case is considered not valid. The procedure is repeated for the 100 initial conditions and a success rate is calculated. FIG. 9 is an example of “hit” and “miss” trajectories for both linear and tumbling trajectories consistent with the present disclosure, and FIG. 13 is an illustrative example of the trajectories of 100 spacecraft needing to be caught by the inflatable with randomized initial conditions.

In some embodiments, instead of using the dynamics of a point particle to model the spacecraft, the dynamics of a rigid body are used. The three components of the moment of inertia (J) are expresses along the principal axis by Equation (11).

$${[ J ]}_{E} = m [ \begin{matrix}1 & 0 & 0 \\ 0 & 2 & 0 \\ 0 & 0 & 3\end{matrix} ] \qquad ( 11 )$$

The equations of motion describing both translation and rotational dynamics of the body can be written from Newton's law and Euler's law in Equation (12).

$$[ \begin{matrix}m I & 0 \\ 0 & J\end{matrix} ] [ \begin{matrix}{\ddot{r}}_{c} \\ \dot{ω}\end{matrix} ] [ \begin{matrix}{F}_{t} \\ τ - ω \times J ω\end{matrix} ] \qquad ( 12 )$$

In Equation (12), re is the position vector of the center of mass of spacecraft relative to observer, m is the mass, and Ft is the force acting on spacecraft, while w and t are the angular velocity components and torque acting on the spacecraft.

The simulation in which spacecraft are modeled as rigid bodies by inflatable is done by randomly selecting the initial position, velocity, and orientation of the body and then evaluating the states by forwarding time using the state dynamics Equation (12). In this work, to resemble the trajectories of objects with that of an abnormally behaving spacecraft, rotational instability about the intermediate moment of inertia axis is utilized. By abnormal behavior, we refer to a possible malfunction of the onboard thruster(s) that may occur due to a problem in the sensor serving the navigation system or due to the interaction of the propulsion system with debris particles. FIG. 10 is an illustrative example of thruster malfunction. This is one example of malfunction that might cause such an abnormal behavior, but there are certainly more. The objective of this second simulation is to generate a tumbling trajectory for various random initial conditions to account for most of the abnormal behavior that a spacecraft can experience. To mimic the tumbling trajectory, initially, the spacecraft is given a spin about the intermediate moment of inertia axis, then a force is applied to the spacecraft such that the force vector doesn't pass through the center of mass of the object and resulting in torque equivalent to r×Ft, where rf is the position vector of force, Ft relative to the center of mass. The torque perturbs the unstable spin state resulting in tumbling rotational motion, and the force vector is fixed relative to the body-fixed frame. It is important to notice that its direction is changing relative to the observer (inflatable structure) due to rotational motion giving rise to the non-rectilinear motion of the center of mass.

In some embodiments, the disclosed system uses Visible Light Communication (VLC) for swarm coordination and traffic management. VLC is a type of optical communication that uses lighting cues to communicate information at a high data rate. Only a small percentage of the optical communications bandwidth is used by visible light. In contrast to the traditional “C Band” radio frequency (RF) communications, which are commonly used for wireless communications for terrestrial and deep space applications, free space optical communication, which employs a significantly more significant portion of the electromagnetic spectrum, has various advantages. Some advantages of free space optical communication over traditional RF communication are high speed, no electromagnetic interference (EMI), higher bandwidth, no bandwidth saturation, lower cost, and the ability to perform dynamic load balancing between RF and optical communication. In some embodiments, the disclosed system uses algorithms based on lighting cues to manage swarm and formation flying.

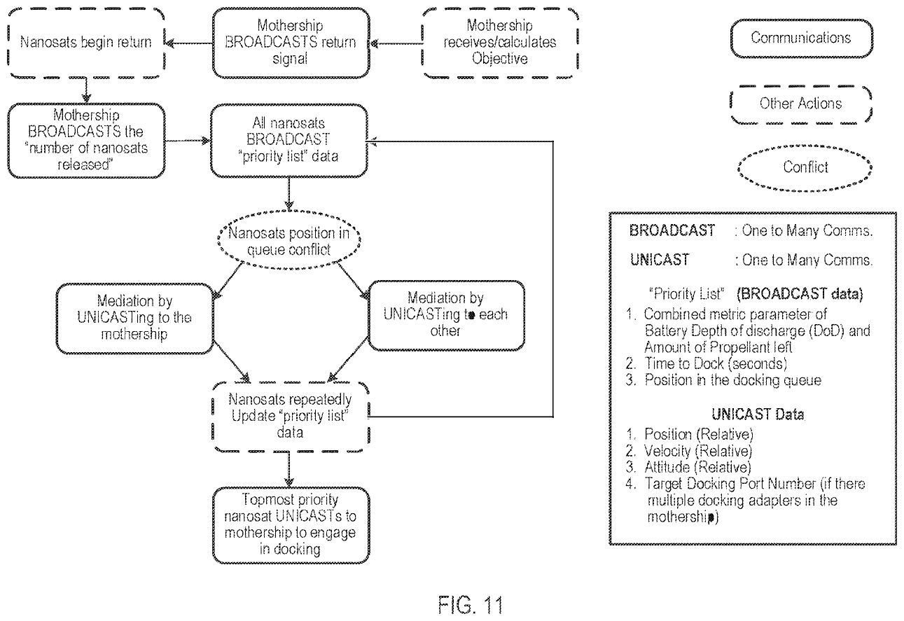

FIG. 11 is an illustrative example block diagram of operations for swarm traffic management using VLC. The illustrative example of FIG. 11 includes communications circuitry to allow for communications with the swarm of spacecraft, and signaling circuitry that may be used in place of, or in addition to, the communications circuitry. This example assumes that the mothership receives an objective either from human input or is capable of calculating the objectives onboard. All satellites possess indicator lights, e.g., LED lights, and light detectors on their external surface. The mothership then “broadcasts” a return message and calculates the number of returning nanosats to all nanosats based on the responses it receives. In some embodiments, a simple On-Off-Keying (OOK) modulation may be sufficient to broadcast this message over short to medium distances, e.g., less than 50 m). All the nanosats then broadcast a “priority list” data table and then update their “priority list” data table based on the responses they receive until they have a position in the docking sequence. Any conflicts that may arise during this update and transmission process are resolved by either “unicasting” or by involving the mothership in the decision-making process. Once all conflicts in the position in the docking queue are resolved, the docking process commences, and the nanosats individually coordinate with the mothership to perform docking.

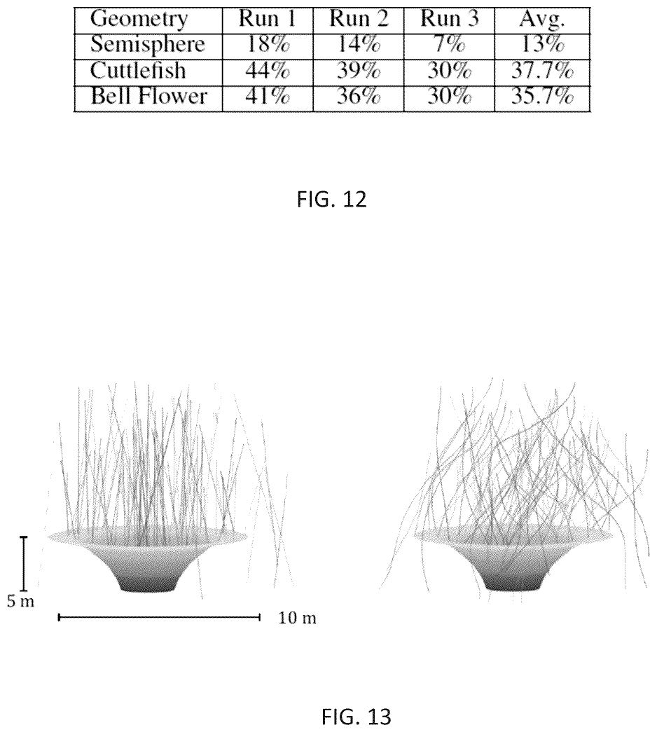

In initial simulation, a total of three runs are performed for each shape, varying the possible range of the spacecraft's positions and velocity initial conditions. Run 1 is performed with a range of x,y,z possible coordinate points within the [0,10] meter range, and a possible velocity range within [−2,2] m s⁻¹ in the x- and y-axis, and within [1,10] m s⁻¹ in the z-axis, to “force” the spacecraft to be moving along the z-axis and either get captured or exit the computational domain. In runs 2 and 3 such ranges are given wider bounds by allowing the generation of spacecraft that are farther away from the motherboard and traveling at higher speeds. The table in FIG. 12 presents the results of such runs in a tabular format. It appears evident that as the distances and velocities are increased, the bell flower and cuttlefish geometries not only are able to capture more spacecraft when compared to the semisphere, but they appear to be able to better retain a higher success rate. In fact, while the cuttlefish and bellflower' success rates structures drop by more than 10 percentage points as the initial conditions are varied, the efficacy of the semisphere drops by more than half its original value. This agrees with logic, as any object that is thrown at a hemisphere or spherical object will more likely bounce off and away from it, never giving it the chance to collide again. Similarly, both the cuttlefish and bell flower provide a “funnel,” or a boundary of sorts that increases the chance of sending the spacecraft towards another point on their surface after the first impact.

Disclosed herein is a novel approach for a wide variety of off-nominal scenarios. Inflatable structures may be used to catch vehicles out of control in both space and ground-based applications. Two scenarios were simulated for each of the three inflatable geometries to better understand the efficacy of each one at successfully catching either a small satellite or an air drone with degraded guidance, navigation, and control capabilities. The first one involved propagating the trajectory of the vessel in a linear motion, while the second scenario considered a damaged actuator such as a propeller for the air drone case or a thruster for a spacecraft. In this case, an impulse force was exerted away from the axis of the center of mass to induce a rotation, then propagated through an inertial matrix, and the tumbling trajectory was propagated. Preliminary results show that cuttlefish or bell flower-like geometries are better able to capture an incoming vehicle with randomized initial conditions and trajectories, both at close range and slow speeds, and far from the impact point while approaching at higher velocities. The induced tumbling about the vessels 3-axis did not seem to significantly impact the success rate of each geometry, although minor differences in success rates can be noted with every consecutive run.

Accordingly, in one aspect the present disclosure provides a system for utilization of swarms for sample return and multipoint observation using inflatables. The system includes a communications circuitry; a signaling circuitry; an inflatable structure; and a first controller, the first controller configured to: receive a message from a target spacecraft indicating a need to be captured; acknowledge the message from the target spacecraft; receive sensitive data from the target spacecraft; determine a location on the inflatable structure for capturing the target spacecraft; signal the target spacecraft to the location; and capture the target spacecraft.

In another aspect, the present disclosure provides a system for swarm traffic management. The system includes a communications circuitry; a signaling circuitry; and a controller, the controller configured to: receive an objective; broadcast a return signal to all spacecraft in a swarm; receive priority data from all spacecraft in the swarm; determine a priority of each spacecraft in the swarm; create a priority list based on the priority of each spacecraft in the swarm; and dock with each spacecraft in the swarm in priority order.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

Embodiments of the methods described herein may be implemented using a controller, processor and/or other programmable device. To that end, the methods described herein may be implemented on a tangible, non-transitory computer readable medium having instructions stored thereon that when executed by one or more processors perform the methods.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A system for utilization of swarms for sample return and multipoint observation using inflatables, the system comprising:
a communications circuitry;
a signaling circuitry;
an inflatable structure; and
a first controller, the first controller configured to:
receive a message from a target spacecraft indicating a need to be captured;
acknowledge the message from the target spacecraft;
receive sensitive data from the target spacecraft;
determine a location on the inflatable structure for capturing the target spacecraft;
signal the target spacecraft to the location; and
capture the target spacecraft.

2. The system of claim 1, wherein the sensitive data includes at least one of relative position, velocity, mass, and possible malfunctions.

3. The system of claim 1, wherein the inflatable structure further comprises:
one or more sensors;
one or more actuators;
one or more signal lights; and
a second controller.

4. The system of claim 3, wherein the one or more sensors include one or more pressure sensors and a Light Detection and Ranging sensor.

5. The system of claim 1, wherein the inflatable structure further comprises a geometry selected from a group consisting of a bell flower, a cuttlefish, and a semisphere.

6. A system for swarm traffic management, the system comprising:
a communications circuitry;
a signaling circuitry; and
a controller, the controller configured to:
receive an objective;
broadcast a return signal to all spacecraft in a swarm;
receive priority data from all spacecraft in the swarm;
determine a priority of each spacecraft in the swarm;
create a priority list based on the priority of each spacecraft in the swarm; and
dock with each spacecraft in the swarm in priority order.

7. The system of claim 6, further comprising:
responsive to a plurality of spacecraft having a same priority in the priority list, send a unicast message to each of the plurality of spacecraft having the same priority;
receive an updated priority data from each of the plurality of spacecraft having the same priority;
update the priority list from the updated priority data; and
responsive to a specific spacecraft having an updated priority that is higher than any remaining spacecraft of the plurality of spacecraft, dock with the specific spacecraft.

8. The system of claim 6, further comprising:
responsive to a plurality of spacecraft having a same priority in the priority list, send a signal to each of the plurality of spacecraft having the same priority to send a unicast message to each other spacecraft of the plurality of spacecraft having the same priority to mediate a new priority;
responsive to the plurality of spacecraft having the same priority having mediated the new priority, receive the new priority from the plurality of spacecraft having the same priority; and
dock with a specific spacecraft having a highest priority.

9. A system for utilization of swarms for sample return and multipoint observation using inflatables, the system comprising:
a communications circuitry;
a signaling circuitry;
an inflatable structure; wherein the inflatable structure further comprises a geometry selected from a group consisting of a bell flower, a cuttlefish, and a semisphere; and
a first controller, the first controller configured to:
receive a message from a target spacecraft indicating a need to be captured;
acknowledge the message from the target spacecraft;
receive sensitive data from the target spacecraft;
determine a location on the inflatable structure for capturing the target spacecraft;
signal the target spacecraft to the location; and
capture the target spacecraft.

10. The system of claim 9, wherein the sensitive data includes at least one of relative position, velocity, mass, and possible malfunctions.

11. The system of claim 9, wherein the inflatable structure further comprises:
one or more sensors;
one or more actuators;
one or more signal lights; and
a second controller.

12. The system of claim 11, wherein the one or more sensors include one or more pressure sensors and a Light Detection and Ranging sensor.
